(19) United States
(12) Patent Application Publication
(10) Pub. No.: US 2012/0245306 A1
(43) Pub. Date: Sep. 27, 2012

(54) ADDUCTS BASED ON DIVINYLARENE OXIDES

(76) Inventor: Maurice J. Marks, Lake Jackson, TX (US)

(21) Appl. No.: 13/503,662

(22) PCT Filed: Dec. 1, 2010
(86) PCT No.: PCT/US2010/058543

§ 371 Date: Apr. 24, 2012

Related U.S. Application Data
(60) Provisional application No. 61/266,376, filed on Dec. 3, 2009.

(51) Int. Cl. C08L 63/00; C08G 59/02

(52) U.S. Cl. 525/526; 528/407

(57) ABSTRACT

A polyamine adduct including the reaction product of (a) a divinylarene dioxide, and (b) an excess of a polyamine to provide an adducted polyamine composition; a process for making the adduct; a curable epoxy resin composition including (i) the adduct derived from divinylbenzene such as divinylbenzene dioxide (DVBDO), (ii) at least one epoxy resin, and (iii) optionally, a co-curing agent and/or a catalyst; and a cured product made from said curable epoxy resin composition. The cured product made from the curable epoxy resin composition is thermally stable and offers improved properties such as a low viscosity and a high heat resistance.

### BACKGROUND OF THE INVENTION

1. Field of the Invention

The present invention is related to adducts based on divinylarene dioxides. More specifically, the present invention is related to amine and/or hydroxyl functional adducts comprising the reaction product of divinylarene dioxides and polyamines to provide adducted polyamines

2. Description of Background and Related Art

In various applications where epoxy resin formulations are employed, adducts of polyamines with minor amounts of epoxy resins are used to improve the compatibility of and to modify the reactivity of polyamines in epoxy resin formulations. For example, U.S. Pat. No. 2,901,461 (“the '461 patent”) describes compositions comprising adducts of polyamines and polyglycidyl ethers; and the use of such adducts in epoxy resin formulations and compositions. However, the formation of said adducts of the prior art causes a significant undesirable increase in viscosity compared to the unmodified polyamine.

For example, the adducts described in U.S. Pat. No. 2,901,461 have disadvantages when used to prepare a curable composition because the adducts either (i) have a benefit of a lower viscosity in the formulation, but have a detriment of a low heat resistance in its derived thermoset; or (ii) have a benefit of a high heat resistance in its derived thermoset but have a high viscosity in the formulation.

For example, D.E.H.™ 52 epoxy hardener from The Dow Chemical Company, an adduct of bisphenol A diglycidyl ether and diethylenetriamine (DETA), has a viscosity of about 6.25 Pa-s and its thermoset with a stoichiometric amount of bisphenol A diglycidyl ether (BADGE) has a glass transition temperature (T_{g}) of about 145° C. In comparison, an adduct of 1 equivalent of butanediol diglycidyl ether and 3 equivalents of DETA as described in WO 2002022709 has a viscosity of about 0.82 Pa-s but its thermoset with a stoichiometric amount of BADGE has a T_{g} of only about 91° C.

U.S. Pat. No. 2,912,389 (“the '389 patent”) describes polymers prepared by reacting divinylbenzene dioxide and polyamines. The resulting product of the '389 patent is a crosslinked polymer product. The '389 patent does not disclose adducts of polyamines which can be used to further crosslink with other epoxy resins and does not disclose an adduct composition having an equivalent ratio of epoxy/NH groups such that the adduct composition cannot form a crosslinked polymer.

What is needed in the industry is an improved epoxy-adducted polyamine composition having a lower viscosity; and an epoxy-adducted polyamine composition that can be used in a curable epoxy resin composition that will not impair the heat resistance of the derived thermoset.

It is desired therefore to provide novel adducts that have both low viscosity and high heat resistance in its derived thermoset; and that cannot crosslink upon complete conversion of the epoxide groups.

### SUMMARY OF THE INVENTION

One embodiment of the present invention is directed to a polyamine adduct comprising the reaction product of (a) a divinylarene dioxide, for example a divinylbenzene dioxide (DVBDO), and (b) a polyamine, for example an ethylene amine or an alkanol amine, to provide an adducted polyamine composition; wherein the composition has a ratio of amine-hydrogen equivalents/epoxide equivalents greater than 5.

Another embodiment of the present invention is directed to a curable epoxy resin composition comprising (a) the above-described polyamine adduct; and (b) at least one epoxy resin other than component (a), for example, a diglycidyl ether of bisphenol A.

The curable epoxy resin compositions containing the above-described polyamine adduct have a low viscosity and upon curing the resulting cured compound has a high heat resistance after curing. Thermosets derived from such compositions based on divinylarene dioxides; and a process for preparing said compositions are also embodiments disclosed herein.

Still other embodiments of the present invention are directed to a process for preparing the polyamine adduct and the curable epoxy resin composition described above.

Another embodiment of the present invention is directed to thermosets derived from the above curable epoxy resin composition having significantly reduced viscosity before cure and higher heat resistance after cure compared to prior art analogs.

In one embodiment, a curable epoxy resin thermoset formulation based on the adduct may be cured to form a thermoset. The resulting curable thermoset formulation may be used in various applications, such as for example, coatings, adhesives, composites, electronics, and the like.

### DETAILED DESCRIPTION OF THE INVENTION

In its broadest scope, the present invention includes a polyamine adduct comprising the reaction product of (a) a divinylarene dioxide, for example a divinylbenzene dioxide (DVBDO), and (b) a polyamine, for example an ethylene amine or an alkanol amine, to provide an adducted polyamine composition. The adduct may then be used to form a curable epoxy resin composition or formulation. The resulting curable epoxy resin composition may include one or more optional additives well known in the art.

One of the advantages of the present invention includes for example DVBDO has a much lower viscosity than other aromatic epoxy resins. Thus, it is possible to incorporate maximum amount of polyamines into the backbone to reach a higher amine hydrogen equivalent weight (AEW) while maintaining lower viscosity.

In the present invention, the divinylarene dioxide such as DVBDO is prepared by reacting a divinylarene and hydrogen peroxide to provide the divinylarene dioxide useful in epoxy resin compositions of the present invention. The resulting divinylarene dioxide product may then be used to prepare the adduct of the present invention.

The divinylarene dioxides useful in the present invention, particularly those derived from divinylbenzene such as for example divinylbenzene dioxide (DVBDO), are class of diepoxides which have a relatively low liquid viscosity but a higher rigidity than conventional epoxy resins. Component (a) of the present invention can therefore include DVBDO and its different isomers.

The divinylarene dioxide useful in the present invention may comprise, for example, any substituted or unsubstituted arene nucleus bearing two vinyl groups in any ring position. The arene portion of the divinylarene dioxide may consist of benzene, substituted benzenes, (substituted) ring-annulated benzenes or homologously bonded (substituted) benzenes, or mixtures thereof. The divinylbenzene portion of the divinylarene dioxide may be ortho, meta, or para isomers or any mixture thereof. Additional substituents may consist of H₂O₂-resistant groups including saturated alkyl, aryl, halogen, nitro, isocyanate, or RO— (where R may be a saturated alkyl or aryl). Ring-annulated benzenes may consist of naphthlalene, tetrahydronaphthalene, and the like. Homologously bonded (substituted) benzenes may consist of biphenyl, diphenylether, and the like.

In one embodiment, the divinylarene dioxide used in the present invention may be produced, for example, by the process described in U.S. Patent Application Ser. No. 61/141,457, filed Dec. 30, 2008 herewith, by Marks et al., incorporated herein by reference.

The divinylarene dioxide used for preparing the composition of the present invention may be illustrated generally by general chemical Structures I-IV as follows:

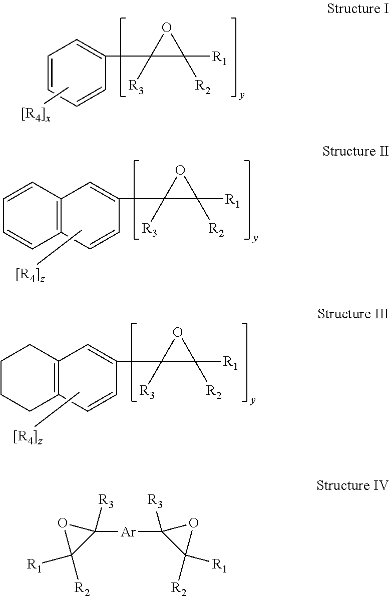

In the above Structures I-IV of the divinylarene dioxide comonomer of the present invention, each R₁, R₂, R₃ and R₄ individually may be hydrogen, an alkyl, cycloalkyl, an aryl or an aralkyl group; or a H₂O₂-resistant group including for example a halogen, a nitro, an isocyanate, or an RO group, wherein R may be an alkyl, aryl or aralkyl; x may be an interger of 0 to 4; y may be an integer greater than or equal to 2; x+y may be an integer less than or equal to 6; z may be an interger of 0 to 6; and z+y may be an integer less than or equal to 8; and Ar is an arene fragment including for example, 1,3-phenylene group.

In another embodiment, the divinylarene dioxide component useful in the present invention may comprise, for example, divinylbenzene dioxide, divinylnaphthalene dioxide, divinylbiphenyl dioxide, divinyldiphenylether dioxide, and mixtures thereof.

In a preferred embodiment of the present invention, the divinylarene dioxide used in the epoxy resin formulation may be for example divinylbenzene dioxide (DVBDO). Most preferably, the divinylarene dioxide component that is useful in the present invention includes, for example, a divinylbenzene dioxide as illustrated by the following chemical formula of Structure V:

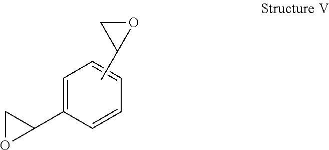

The chemical formula of the above DVBDO compound may be as follows: C₁₀H₁₀O₂; the molecular weight of the DVBDO is about 162.2; and the elemental analysis of the DVBDO is about: C, 74.06; H, 6.21; and 0, 19.73 with an epoxide equivalent weight of about 81 g/mol.

Divinylarene dioxides, particularly those derived from divinylbenzene such as for example divinylbenzene dioxide (DVBDO), are class of diepoxides which have a relatively low liquid viscosity but a higher rigidity and crosslink density than conventional epoxy resins.

Structure VI below illustrates an embodiment of a preferred chemical structure of the DVBDO useful in the present invention:

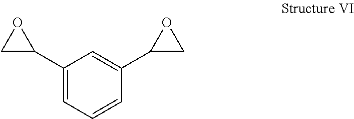

Structure VII below illustrates another embodiment of a preferred chemical structure of the DVBDO useful in the present invention:

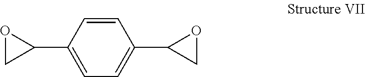

When DVBDO is prepared by the processes known in the art, it is possible to obtain one of three possible isomers: ortho, meta, and para. Accordingly, the present invention includes a DVBDO illustrated by any one of the above Structures individually or as a mixture thereof. Structures VI and VII above show the meta (1,3-DVBDO) isomer and the para (1,4-DVBDO) isomer of DVBDO, respectively. The ortho isomer is rare; and usually DVBDO is mostly produced generally in a range of from about 9:1 to about 1:9 ratio of meta isomer (Structure VI) to para isomer (Structure VII). The present invention preferably includes as one embodiment a range of from about 6:1 to about 1:6 ratio of Structure VI to Structure VII, and in other embodiments the ratio of Structure VI to Structure VII may be from about 4:1 to about 1:4 or from about 2:1 to about 1:2.

In another embodiment of the present invention, the divinylarene dioxide may contain quantities (such as for example less than about 20 weight percent) of substituted arenes. The amount and structure of the substituted arenes depend on the process used in the preparation of the divinylarene precursor to the divinylarene dioxide. For example, divinylbenzene prepared by the dehydrogenation of diethylbenzene (DEB) may contain quantities of ethylvinylbenzene (EVB) and DEB. Upon reaction with hydrogen peroxide, EVB produces ethylvinylbenzene monoxide while DEB remains unchanged. The presence of these compounds can increase the epoxide equivalent weight of the divinylarene dioxide to a value greater than that of the pure compound.

In one embodiment, the divinylarene dioxide, for example divinylbenzene dioxide (DVBDO), useful in the present invention comprises a low viscosity liquid epoxy resin (LER) composition. The viscosity of the divinylarene dioxide used in the process for making the epoxy resin composition of the present invention ranges generally from about 10 mPa-s to about 100 mPa-s, preferably from about 10 mPa-s to about 50 mPa-s, and more preferably from about 10 mPa-s to about 25 mPa-s at 25° C.

Another advantageous property of the divinylarene dioxide useful in the present invention may be for example its rigidity. The rigidity property of the divinylarene dioxide is measured by a calculated number of rotational degrees of freedom of the dioxide excluding side chains using the method of Bicerano described in Prediction of Polymer Properties, Dekker, New York, 1993. The rigidity of the divinylarene dioxide used in the present invention may range generally from about 6 to about 10, preferably from about 6 to about 9, and more preferably from about 6 to about 8 rotational degrees of freedom.

The concentration of the divinylarene dioxide used to prepare the adduct of the present invention may range generally from about 1 weight percent (wt %) to about 99 wt %; preferably, from about 5 wt % to about 95 wt %; and more preferably, from about 10 wt % to about 90 wt %, such that the ratio of amine-hydrogen equivalents/epoxide equivalents greater than 5.

The polyamines, component (b), useful in the present invention may be any conventional polyamine known in the art. For the purposes of the present invention, a “polyamine” herein includes the generic class of polyamines and alkanolamines conventionally known in the art. In one embodiment, the polyamine used in the present invention may be any amine compound conventionally known in the art, including as the amine compounds described in U.S. Pat. No. 2,912,389, incorporated herein by reference. For example, aliphatic amines such as diethylenetriamine, cycloaliphatic amines such as isophoronediamine, alkanolamines such as diethanolamine, aralkylamines such as xylenediamine, arylamines such as toluenediamine, and mixtures thereof may be used in the present invention.

For example, the polyamines useful in the practice of the present invention composition may be the hydroxyalkyl alkylene polyamines described in U.S. Pat. No. 2,901,461, incorporated herein by reference; including for example N-hydroxyethyl ethylene diamine; N-hydroxyethyl pentamethylene diamine; N-hydroxypropyl tetramethylene diamine; N-hydroxyethyl diethylene triamine; N,N-dihydroxyethyl diethylene triamine; N,N″-dihydroxyethyl diethylene triamine; N-hydroxypropyl diethylene triamine; N,N-dihydroxypropyl diethylene triamine; N,N″-dihydoxypropyl diethylene triamine; N-hydroxyethyl propylene diamine; N.hydroxypropyl propylene diamine; N-hydroxyethyl dipropylene triamine; N-dihydroxyethyl dipropylene triamine; N,N′-dihydoxyethyl dipropylene triamine; tris-hydroxyethyl triethylene tetramine; and mixtures thereof.

In one embodiment, the polyamines, component (b) of the present invention, which is used to react with the divinylarene dioxide of the present invention to provide an amine and hydroxyl functional adduct may include for example alkanolamines such as ethanolamine, diethanolamine, tris(hydroxymethyl)aminomethane; 4-(2-hydroxyethyl)-piperazine; 2-amino-butanol; 2-amino-2-methyl-1,3-propanediols; and combination thereof. Other alkanolamines useful in the present invention are those described in U.S. Patent Publication No. 2004/0147690A1, incorporated herein by reference.

As another embodiment, alkanolamines as shown in the following chemical structures may be used:

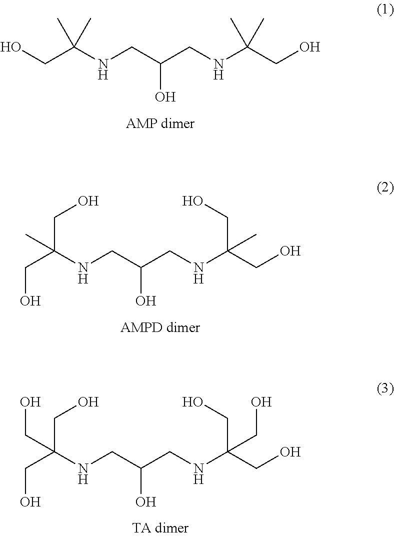

Examples of some of the optional components that may be used in the composition of the present invention include reaction catalysts such as other amines, other epoxy resins, phenols such as bisphenol A, and solvents: and mixtures thereof.

The preparation of the polyamine adduct of the present invention is achieved by adding to a reactor: a divinylarene dioxide, a polyamine, and optionally a solvent; and then allowing the components to react under reaction conditions to produce the polyamine adduct. The components are heated until the desired degree of reaction is achieved. The resulting product is allowed to cool prior to or during isolation and is immediately usable in thermoset formulations.

The reaction conditions to form the adduct include carrying out the reaction under a temperature, generally in the range of from about 0° C. to about 200° C.; preferably, from about 20° C. to about 180° C.; and more preferably, from about 40° C. to about 160° C. The pressure of the reaction may be from about 0.1 bar to about 10 bar; preferably, from about 0.2 bar to about 5 bar: and more preferably, from about 0.5 bar to about 2 bar.

The reaction process of the present invention may be a batch or a continuous. The reactor used in the process may be any reactor and ancillary equipment well known to those skilled in the art.

The novel adducts of divinylarene dioxides and polyamines are amine-functional compositions having a lower viscosity with high heat resistance of derived thermosets compared to adducts of the prior art.

The viscosity of the adducts prepared by the process of the process of the present invention ranges generally from about 0.1 Pa-s to about 900 Pa-s; preferably, from about 1 Pa-s to about 500 Pa-s; and more preferably, from about 2 Pa-s to about 100 Pa-s at 25° C.

The amine equivalent weight (AEW) of the adduct prepared by the process of the process of the present invention ranges generally from about 16 to about 46; preferably, from about 18 to about 45; and more preferably, from about 20 to about 45.

The adduct of the present invention is useful, for example, as a curing agent (hardener or crosslinking agent) component in a curable or thermosettable formulation or composition. For example, the adduct of the present invention is useful as hardener component in an epoxy thermoset formulation. The amine and hydroxyl functional adducts of the present invention can be used, for example, as curing agents for epoxy resins. The amine and hydroxyl functional adducts of the present invention can be used as catalysts to catalyze an epoxy and anhydride cure formulation. The amine and hydroxyl functional adducts of the present invention may also be used as catalysts for a polyol and isocyanate formulation. The amine and hydroxyl functional adducts of the present invention may also be used as epoxy curing catalysts.

Accordingly, to illustrate embodiments of the present invention, there are two types of amine functional adducts which can be made in accordance with the present invention:

1. Low viscosity resins so that the resin stays liquid at room temperature. For example, the low viscosity resins can be added to a phenolic hardener as an adhesion promoter.

2. Solid amine functional resins where more epoxy DVBDO is used to advance other amines to a higher AEW so that the resins stay solid at room temperature. For example, the solid amine functional resins can be used as a non-sintering hardener for powder coating applications.

In another broad aspect of the present invention, a curable epoxy resin composition may be prepared comprising a mixture of: (i) the above described adduct; (ii) at least one epoxy resin; (iii) optionally, a curing agent; and (iv) optionally, a curing catalyst.

The first component (i) of the curable epoxy resin composition comprises the polyamine adduct, as described above.

The first component (i) may optionally contain other amines, polyamines, or adducted amines. Examples of these optional compounds are listed above. The optional amine may be present in concentrations ranging from about 1 wt. % to about 99 wt. %, preferably from about 5 wt. % to about 95 wt. %, and most preferably from about 10 wt. % to about 90 wt. %.

The concentration of the component (i) polyamine adduct used in the curable mixture of the present invention may range generally from a value of the ratio rₐ of amine equivalents to epoxide equivalents of about 0.01 to about 1; preferably, from about 0.05 to about 1 and more preferably, from about 0.10 to about 1. At values of rₐ of less than 0.01 the polyamine adduct concentration is insignificant in the formulation, whereas values greater than 1 can be used but after curing leave unreacted adduct in the cured composition.

In preparing the epoxy resin composition mixture of the present invention, in addition to the adduct described above, the mixture may include at least one epoxy resin, component (ii). Epoxy resins are those compounds containing at least one vicinal epoxy group. The epoxy resin may be saturated or unsaturated, aliphatic, cycloaliphatic, aromatic or heterocyclic and may be substituted. The epoxy resin may also be monomeric or polymeric. The epoxy resin useful in the present invention may be selected from any known epoxy resins in the art. An extensive enumeration of epoxy resins useful in the present invention is found in Lee, H. and Neville, K., “Handbook of Epoxy Resins,” McGraw-Hill Book Company, New York, 1967, Chapter 2, pages 257-307; incorporated herein by reference.

The epoxy resins, used in embodiments disclosed herein for component (ii) of the present invention, may vary and include conventional and commercially available epoxy resins, which may be used alone or in combinations of two or more. In choosing epoxy resins for compositions disclosed herein, consideration should not only be given to properties of the final product, but also to viscosity and other properties that may influence the processing of the resin composition.

Particularly suitable epoxy resins known to the skilled worker are based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known to the skilled worker include reaction products of epichlorohydrin with o-cresol and, respectively, phenol novolacs. It is also possible to use a mixture of two or more epoxy resins.

The epoxy resin, component (ii), useful in the present invention for the preparation of the epoxy resin composition, may be selected from commercially available products. For example, D.E.R. 331, D.E.R.332, D.E.R. 334, D.E.R. 580, D.E.N. 431, D.E.N. 438, D.E.R. 736, or D.E.R. 732 available from The Dow Chemical Company may be used. As an illustration of the present invention, the epoxy resin component (a) may be a liquid epoxy resin, D.E.R.® 383 (DGEBPA) having an epoxide equivalent weight of 175-185, a viscosity of 9.5 Pa-s and a density of 1.16 gms/cc. Other commercial epoxy resins that can be used for the epoxy resin component can be D.E.R. 330, D.E.R. 354, or D.E.R. 332.

Other suitable epoxy resins useful in the present invention are disclosed in, for example, U.S. Pat. Nos. 3,018,262.7,163,973, 6,887,574, 6,632,893, 6,242,083, 7,037,958, 6,572,971, 6,153,719, and 5,405,688, PCT Publication WO 2006/052727; U.S. Patent Application Publication Nos. 20060293172, 20050171237, 2007/0221890 A1; each of which is hereby incorporated herein by reference.

In a preferred embodiment, the epoxy resin useful in the composition of the present invention comprises any aromatic or aliphatic glycidyl ether or glycidyl amine or a cycloaliphatic epoxy resin. In another preferred embodiment, the epoxy resin useful in the composition of the present invention comprises a divinylarene dioxide, preferably divinylbenzene dioxide.

In general, the choice of the epoxy resin used in the present invention depends on the application. However, diglycidyl ether of bisphenol A (DGEBA) and derivatives thereof are particularly preferred. Other epoxy resins can be selected from but limited to the groups of: bisphenol F epoxy resins, novolac epoxy resins, glycidylamine-based epoxy resins, alicyclic epoxy resins, linear aliphatic epoxy resins, tetrabromobisphenol A epoxy resins, and combinations thereof.

The component (ii) epoxy resin may be present in the curable mixture composition at a concentration ranging generally from a value of the ratio rₑ of epoxide equivalents to amine equivalents of about 10 to about 1; preferably, from about 5 to about 1 and more preferably, from about 2 to about 1. At values of rₑ of greater than 10 the polyamine adduct concentration is insignificant in the formulation, whereas values less than 1 can be used but after curing leave unreacted adduct in the cured composition.

An assortment of additives may be optionally added to the compositions of the present invention including for example, curing agents, catalysts, solvents, other resins, stabilizers, fillers, plasticizers, catalyst de-activators, and mixtures thereof.

In one embodiment, for example, a curable composition comprising a reactive thermosettable epoxy resin composition includes a reaction mixture of (i) an adduct of a divinylarene dioxide and polyamine as described above, (ii) at least one epoxy resin, (iii) optionally, at least one co-curing agent, and (iv) optionally, at least one catalyst.

The optional co-curing agent, component (iii), useful for the curable epoxy resin composition of the present invention, may comprise any conventional curing agent known in the art for curing epoxy resins. The co-curing agents, (also referred to as a co-hardener or co-cross-linking agent) useful in the thermosettable composition, may be selected, for example, from those curing agents well known in the art including, but are not limited to, anhydrides, carboxylic acids, amine compounds, phenolic compounds, polyols, or mixtures thereof.

Examples of the optional co-curing agent useful in the present invention may include any of the curing materials known to be useful for curing epoxy resin based compositions. Such materials include, for example, polyamine, polyamide, polyaminoamide, dicyandiamide, polyphenol, polymeric thiol, polycarboxylic acid and anhydride, polyol, tertiary amine, quaternary ammonium halide, and any combination thereof or the like. Other specific examples of the curing agent include phenol novolacs, bisphenol-A novolacs, phenol novolac of dicyclopentadiene, cresol novolac, diphenylsulfone, styrene-maleic acid anhydride (SMA) copolymers; and any combination thereof. The co-curing agents sensitive to the presence of water/ethanol in the composition (e.g. anhydrides) are usually not recommended. Among the conventional epoxy curing agents, amines and amino or amido containing resins are preferred.

Dicyandiamide (“dicy”) may be one preferred embodiment of the co-curing agent useful in the present invention. Dicy has the advantage of providing delayed curing since dicy requires relatively high temperatures for activating its curing properties; and thus, dicy can be added to an epoxy resin and stored at room temperature (about 25° C.).

The amount of the co-curing agent used in the epoxy resin composition generally ranges from 0 to about 99, preferably from about 1 to about 90, and more preferably from about 5 to about 95 eq. % of the total of the curing agents used in the formulation. The use of higher eq. % of a co-curing agent allows only an insignificant amount of polyamine adduct in the formulation.

In preparing the curable compositions of the present invention, at least one catalyst may also optionally be used. The catalyst used in the present invention may be adapted for polymerization, including homopolymerization, of the at least one epoxy resin. Alternatively, catalyst used in the present invention may be adapted for a reaction between the at least one epoxy resin and the at least one curing agent, if used.

The optional catalyst, component (iv), useful in the present invention may include catalysts well known in the art, such as for example, catalyst compounds containing amine, phosphine, heterocyclic nitrogen, ammonium, phosphonium, arsonium, sulfonium moieties, and any combination thereof. Some non-limiting examples of the catalyst of the present invention may include, for example, ethyltriphenylphosphonium; benzyltrimethylammonium chloride; heterocyclic nitrogen-containing catalysts described in

U.S. Pat. No. 4,925,901, incorporated herein by reference; imidazoles; triethylamine; and any combination thereof.

The selection of the catalyst useful in the present invention is not limited and commonly used catalysts for epoxy systems can be used. Also, the addition of a catalyst is optional and depends on the system prepared. When the catalyst is used, preferred examples of catalyst include tertiary amines, imidazoles, organo-phosphines, and acid salts.

Most preferred catalysts include tertiary amines such as, for example, triethylamine, tripropylamine, tributylamine, 2-methylimidazole, benzyldimethylamine, mixtures thereof and the like.

The concentration of the optional catalyst used in the present invention may range generally from 0 wt % to about 25 wt %, preferably from about 0.01 wt % to about 20 wt %, more preferably from about 0.01 wt % to about 15 wt %, and most preferably from about 0.01 wt % to about 10 wt %. The use of higher concentrations of optional catalyst can adversely affect the properties of the cured composition.

In still another embodiment of the present invention, one or more optional organic solvents well known in the art may be used in the curable epoxy resin composition. For example, aromatics such as xylene, ketones such as methyl ether ketone, and alcohols such as 1-methoxy-2-propanol; and mixtures thereof, may be used in the present invention.

The concentration of the optional solvent used in the present invention may range generally from 0 wt % to about 90 wt %, preferably from about 0.01 wt % to about 80 wt %, more preferably from about 1 wt % to about 70 wt %, and most preferably from about 5 wt % to about 50 wt %.

The curable or thermosettable composition of the present invention may optionally contain one or more other additives which are useful for their intended uses. For example, the optional additives useful in the present invention composition may include, but not limited to, stabilizers, surfactants, flow modifiers, pigments or dyes, matting agents, degassing agents, flame retardants (e.g., inorganic flame retardants, halogenated flame retardants, and non-halogenated flame retardants such as phosphorus-containing materials), toughening agents, curing initiators, curing inhibitors, wetting agents, colorants or pigments, thermoplastics, processing aids, UV blocking compounds, fluorescent compounds, UV stabilizers, inert fillers, fibrous reinforcements, antioxidants, impact modifiers including thermoplastic particles, and mixtures thereof. The above list is intended to be exemplary and not limiting. The preferred additives for the, formulation of the present invention may be optimized by the skilled artisan.

The concentration of the additional additives is generally between 0 wt % to about 90 wt %; preferably, between about 0.01 wt % to about 80 wt %; more preferably, between about 1 wt % to about 70 wt %; and most preferably, between about 1 wt % to about 50 wt % based on the weight of the total composition. At concentrations above these ranges, the properties of the curable composition are adversely affected.

The preparation of the epoxy resin composition of the present invention is achieved by admixing in a vessel the following components: the adduct, an epoxy resin, optionally a co-curing agent, optionally a catalyst, and optionally an inert organic solvent; and then allowing the components to formulate into an epoxy resin composition. There is no criticality to the order of mixture, i.e., the components of the formulation or composition of the present invention may be admixed in any order to provide the thermosettable composition of the present invention. Any of the above-mentioned optional assorted formulation additives, for example fillers, may also be added to the composition during the mixing or prior to the mixing to form the composition.

All the components of the epoxy resin composition are typically mixed and dispersed at a temperature enabling the preparation of an effective epoxy resin composition having a low viscosity for the desired application. The temperature during the mixing of all components may be generally from about 0° C. to about 100° C. and preferably from about 0° C. to about 50° C. At temperatures below the above ranges, the viscosity of the formulation becomes excessive, while at temperatures above the ranges, the formulation can react prematurely.

The epoxy resin composition of the present invention, prepared from the divinylarene dioxides described above, have improved heat resistance at the same molecular weight or lower viscosity at the same heat resistance compared to known compositions in the art.

The curable formulation or composition of the present invention can be cured under conventional processing conditions to form a thermoset. The resulting thermoset displays excellent thermo-mechanical properties, such as good toughness and mechanical strength, while maintaining high thermal stability.

The process to produce the thermoset products of the present invention may be performed by gravity casting, vacuum casting, automatic pressure gelation (APG), vacuum pressure gelation (VPG), infusion, filament winding, lay up injection, transfer molding, prepreging, dipping, coating, spraying, brushing, and the like.

The curing reaction conditions include, for example, carrying out the reaction under a temperature, generally in the range of from about 0° C. to about 300° C.; preferably, from about 0° C. to about 250° C.; and more preferably, from about 0° C. to about 200° C. At temperatures below the above ranges, the curing rate of the composition is generally too slow, while at temperatures above these ranges, the formulation can react prematurely.

The curing process of the present invention may be a batch or a continuous process. The reactor used in the process may be any reactor and ancillary equipment well known to those skilled in the art.

The cured or thermoset product prepared by curing the epoxy resin composition of the present invention advantageously exhibits an improved balance of thermo-mechanical properties (e.g. transition temperature, modulus, and toughness). The cured product can be visually transparent or opalescent.

The present invention is directed to preparing amine and hydroxyl functional adducts for epoxy cure applications in the field of coatings, films, adhesives, encapsulations, castings, composites, laminates, electronics, electrical laminates, insulation, civil engineering and construction; and the like. The amine and hydroxyl functional adducts of the present invention may be cured with an epoxy at low temperature with increase reactivity and better adhesion to the surface. The compositions of the present invention may be used in the above fields by curing the amine groups of the amine and hydroxyl functional adducts of the present invention with epoxy resins with or without the combination of other amines.

As an illustration of the present invention, in general, the epoxy resin compositions may be useful for casting, potting, encapsulation, molding, and tooling. The present invention is particularly suitable for all types of electrical casting, potting, and encapsulation applications; for molding and plastic tooling; and for the fabrication of epoxy based composites parts, particularly for producing large epoxy-based parts produced by casting, potting and encapsulation. The resulting composite material may be useful in some applications, such as electrical casting applications or electronic encapsulations, castings, moldings, potting, encapsulations, injection, resin transfer moldings, composites, coatings and the like.

### EXAMPLES

The following examples and comparative examples further illustrate the present invention in detail but are not to be construed to limit the scope thereof.

Various terms and designations are used in the following examples wherein “EEW” stands for epoxide equivalent weight; “AEW” stands for amine equivalent weight; “DVBDO” stands for divinylbenzene dioxide; D.E.H. 20 epoxy hardener is a technical grade of diethylenetriamine commercially available from The Dow Chemical Company; D.E.H. 52 epoxy hardener is an adducted amine commercially available from The Dow Chemical Company; and “BADGE” stands for bisphenol A diglycidyl ether.

Various standard analytical equipments and methods are used in the Examples, for example, viscosity is measured by an ARES Rheomechanical Analyzer.

### Examples 1-4 and Comparative Examples A-B

DVBDO and D.E.H. 20 grade diethylenetriamine were allowed to react in the proportions indicated in Table I at 90° C. for 1 hr. to effect complete conversion of the epoxide groups. Table I shows the amine/epoxide molar and equivalent ratios and the adduct AEW values and viscosity.

TABLE I
Adduct Rheology

| | | | | η⁽⁴⁾ |
|---|---|---|---|---|
| Example | m⁽¹⁾ | e⁽²⁾ | AEW⁽³⁾ | (Pa-s) |
| Comp. Ex. A | 2.0 | 5.0 | 47 | 925.91 |
| [DEH 20 + DVBDO] | | | | |
| Ex. 1 | 2.4 | 6.0 | 41 | 65.70 |
| [DEH 20 + DVBDO] | | | | |
| Ex. 2 | 2.6 | 6.5 | 40 | 26.69 |
| [DEH 20 + DVBDO] | | | | |
| Ex. 3 | 2.8 | 7.0 | 38 | 13.85 |
| [DEH 20 + DVBDO] | | | | |
| Ex. 4 | 3.0 | 7.5 | 37 | 7.55 |
| [DEH 20 + DVBDO] | | | | |
| Comp. Ex. B | 4.0 | 10.0 | 45 | 6.25 |
| [DEH-52] | | | | |

Notes for Table I:
⁽¹⁾m = moles DEH 20/moles DVBDO;
⁽²⁾e = amine hydrogen equivalents/epoxide equivalents;
⁽³⁾AEW = amine hydrogen equivalent weight (calculated);
⁽⁴⁾Viscosity at 25° C. and freq. = 10 s⁻¹.

### Comparative Example C

DEH 52, having a viscosity of about 6.25 Pa-s, is cured with a stoichiometric amount of BADGE to give a thermoset having a T_{g} of about145° C.

### Comparative Example D

An adduct of 1 equivalent of butanediol diglycidyl ether and 3 equivalents of DETA as described in WO 2002022709 having a viscosity of about 0.82 Pa-s is cured with a stoichiometric amount of BADGE to give a thermoset having a T_{g} of about 91° C.

### Examples 5-8 and Comparative Example E

Examples shown in Table I are cured with a stoichiometric amount of BADGE to give a thermoset having the indicated T_{g}.

TABLE II
Adduct Thermosets

| Example | Adduct | T_{g} (° C.) |
|---|---|---|
| Comparative | Comparative Example A | 151 |
| Example E | [DEH 20 + DVBDO] | |
| 5 | Example 1 [DEH 20 + DVBDO] | 150 |
| 6 | Example 2 [DEH 20 + DVBDO] | 149 |
| 7 | Example 3 [DEH 20 + DVBDO] | 149 |
| 8 | Example 4 [DEH 20 + DVBDO] | 149 |

The adducts of the present invention have lower viscosity than the divinylarene dioxide adducts of the prior art without significantly decreasing the T_{g} in the derived thermosets.

1. A polyamine adduct comprising the reaction product of (a) a divinylarene dioxide, and (b) an excess of a polyamine to provide an adducted polyamine composition; wherein the composition has a ratio of amine-hydrogen equivalents/epoxide equivalents greater than 5.

2. A curable epoxy resin composition comprising (i) the polyamine adduct of claim 1; and (ii) at least one epoxy resin composition.

3. The composition of claim 1 or claim 2, wherein the ratio of amine-hydrogen equivalents/epoxide equivalents is greater than or equal to 6.

4. The composition of claim 1 or claim 2, including a co-curing agent.

5. The composition of claim 1 or claim 2, including a catalyst.

6. The composition of claim 1 or claim 2, wherein the divinylarene dioxide is divinylbenzene dioxide.

7. The composition of claim 4, wherein the co-curing agent comprises a polyamine.

8. The composition of claim 4, wherein the concentration of said co-curing agent ranges from about 1 to about 99 eq. % of the total of the curing agents used in the formulation.

9. The composition of claim 5, wherein the catalyst comprises catalyst compounds containing amine, phosphine, heterocyclic nitrogen, ammonium, phosphonium, arsonium, sulfonium moieties, and any combination thereof.

10. The composition of claim 5, wherein the concentration of said catalyst ranges from about 0.01 weight percent to about 25 weight percent.

11. A process for preparing a polyamine adduct comprising reacting (a) a divinylarene dioxide, and (b) a polyamine to provide an adducted polyamine composition; wherein the composition has a ratio of amine-hydrogen equivalents/epoxide equivalents greater than 5.

12. A process for preparing a curable epoxy resin composition comprising admixing (a) the polyamine adduct of claim 1; and (b) at least one epoxy resin.

13. The process of claim 12, wherein the epoxy resin is divinylbenzene dioxide.

14. The process of claim 11 or claim 12, wherein the process is carried out at a temperature in the range of from about 0° C. to about 200° C.
